(19) United States
(12) Patent Application Publication
(10) Pub. No.: US 2024/0117848 A1
(43) Pub. Date: Apr. 11, 2024

(54) ATTENUATOR FOR NOISE GENERATED BY A CENTRIFUGAL PUMP

(71) Applicants: TALLANO TECHNOLOGIES, PARIS (FR); AKWEL, CHAMPFROMIER (FR)

(72) Inventor: Pascal GUERRY, SEPPOIS LE HAUT (FR)

(21) Appl. No.: 18/554,392

(22) PCT Filed: Apr. 5, 2022
(86) PCT No.: PCT/EP2022/059032

§ 371 Date: Oct. 6, 2023

(30) Foreign Application Priority Data
Apr. 8, 2021 (FR) FR2103612

(51) Int. Cl. F16D 65/00; F04D 17/08; F04D 29/66; F04D 29/70

(52) U.S. Cl. CPC F16D 65/0031; F04D 17/08; F04D 29/665; F04D 29/701; B60T 17/008

(57) ABSTRACT

Disclosed is an acoustic attenuation device for an electromechanical device through which a gas stream passes which is capable of propagating acoustic waves. The device includes inlet ports and outlet ports for a gas stream, in particular for the purpose of releasing the gas stream into the atmosphere. The device includes a generally annular channel defining a substantially circular flow path for the gas stream about a main axis between the inlet and outlet ports, and a plurality of acoustic attenuator elements which are tuned to an attenuation resonance frequency with an associated attenuation frequency band and are distributed in series circularly along the channel so as to interact with the gas stream flowing in the channel, the acoustic attenuator elements being formed by cavities of quarter-wave resonators.

### CROSS-REFERENCE TO RELATED APPLICATIONS

This application is the US national stage of PCT/EP2022/059032, filed Apr. 5, 2022 and designating the United States, which claims the priority of FR FR2103612, filed Apr. 8, 2021. The entire contents of each foregoing application are incorporated herein by reference.

### BACKGROUND OF THE INVENTION

### Field of the Invention

This invention relates to a noise attenuator, in particular for noise generated by a turbine of a centrifugal pump. It applies more particularly but not specifically to a device for recovering braking dust particles, in particular those emitted during braking action of a motor vehicle, in which air is suctioned by means of such a centrifugal pump. The field of application of the invention relates more particularly but not exclusively to the recovery of braking dust generated during braking action of a vehicle, whether a road vehicle (for example: automobile, heavy truck, motorcycle) or a railway vehicle (train, tram, subway).

### Description of the Related Art

In general, the braking of a railway or road vehicle, and in particular of a motor vehicle, is achieved by a friction braking system, as is the case for example with “disc brakes”. The invention can be applied to other types of braking systems, such as drum brakes or any other type of friction brake. A disc brake comprises a disc rotating around an axle fixed to a hub of a wheel of the vehicle, and brake pads provided with linings made of friction material and mounted on either side of the disc by means of a brake caliper.

During a braking action, the brake pads, which are movable relative to the caliper, bear against the discs rotatably connected to the wheels of the vehicle, in order to apply braking torque to them and enable braking by conversion of kinetic energy into heat.

However, with each braking action, in addition to the release of heat, the friction of the brake pads causes wear on the friction materials of the linings, as well as wear on the metal discs or drums. This abrasive wear produces significant particle emission. Since the brakes of a motor vehicle are generally not completely enclosed, these particles of braking dust are then released directly into the ambient environment.

In addition to fouling the immediate environment of the wheels and in particular the rims, more importantly these particles are harmful to health. These particles can be nanoparticles or microparticles, the finest particles being recognized as particularly harmful to individuals' health in general, with an increased risk of developing respiratory, allergic, and cardiovascular diseases.

In order to reduce pollution from braking dust particles, it is known in the state of the art to place a particle filtering device near the braking system.

Such a filtration device comprises a housing which defines a collection body and which houses for example a filtration member such as a particle filter and/or a cyclonic structure, the housing comprising a flow inlet for dirty air and a flow outlet for purified air, the air circulating between the inlet and the outlet through the filter and/or the cyclonic structure.

In order to cause air to circulate inside the housing, it is known from the prior art to connect the outlet of the housing to a “turbine”, which is the designation commonly used to designate a centrifugal pump.

In a manner that is known per se, such a pump is generally in the form of a pump body which is a volute housing a rotating propeller that suctions axially into the pump, radially accelerates, and finally tangentially discharges the purified air exiting the housing after filtration.

In this manner, the dust generated by friction between the brake lining and the wheel during braking is captured and filtered in the filtration device. Indeed, by means of the centrifugal suction pump, a flow of dust-laden air is sucked into the filtration housing. The air flow is purified as it travels through filtration unit(s) before reaching the centrifugal pump which will send it on outside.

However, the filtration device with centrifugal pump has the disadvantage of being a source of significant noise pollution over a range of potentially undesirable sound frequencies and a potential cause of complaint for motor vehicle users.

### SUMMARY OF THE INVENTION

The purpose of the invention is in particular to remedy this disadvantage by making it possible to reduce the noise resulting from operation of the centrifugal pump, with minimum space requirements and a significant range of sound frequency damping.

To this end, one object of the invention is an acoustic attenuation device for an electromechanical device through which passes a gas stream capable of propagating acoustic waves, comprising inlet and outlet ports for a gas stream, in particular for the purpose of release into the atmosphere, characterized in that the device comprises a channel of an overall shape that is generally curvilinear around a main axis of the device, defining a substantially curvilinear flow path for the gas stream between the inlet and outlet ports, and comprises a plurality of acoustic attenuator elements tuned to an attenuation resonance frequency, arranged consecutively in series along said channel so as to interact with the gas stream flowing in the channel, the acoustic attenuator elements being formed by cavities of quarter-wave resonators.

Due to this curvilinear arrangement around the main axis of the resonators in the acoustic attenuation channel, the acoustic attenuation device is compact because it can be easily installed inside a centrifugal pump body. In particular, due to the invention, it is possible to arrange a plurality of resonators within a reduced space while enabling an attenuation of sound frequencies over an expanded frequency range.

In a preferred embodiment, the channel has an overall shape that is generally annular around the axis, defining a near-circular flow path between the inlet and outlet ports.

In a preferred embodiment, the channel at least partially winds in an outwardly expanding spiral configuration between the inlet port and the outlet port.

In a preferred embodiment, the channel is provided with an internal geometric structure extending inside the channel in a substantially circumferential direction, configured to define the plurality of cavities and to leave free of obstructions to the flow of the gas stream a main passage which the cavities are open to.

In a preferred embodiment, the internal geometric structure comprises a plurality of radial separation partitions which define, with the walls of the channel, a plurality of compartments forming the plurality of cavities.

In a preferred embodiment, a wall of the channel has a stepped profile defining an incremental depth which varies from one cavity to another along a circumferential direction of the channel.

In a preferred embodiment, the depth from one cavity to another varies increasingly or decreasingly over the series of resonators, in the direction going from the inlet to the outlet.

In a preferred embodiment, with at least first and second resonators having first and second resonance frequencies respectively associated with first and second frequency bands of attenuation greater than twenty decibels, the circumferential distance between the two resonators is determined so as to produce a coupling phenomenon between the two resonators over a continuous frequency band of attenuation greater than twenty decibels.

Circumferential distance is understood to mean the distance separating two elements along a circumferential centerline of the channel

In a preferred embodiment, an optimal spacing Popt(i) between two consecutive resonators Ai and Ai+1 being given by the following formula:

$$Popt ( i ) = \frac{v}{8} \times ( \frac{1}{f {0}_{i}} + \frac{1}{f {0}_{i + 1}} )$$

where f0(i) is the resonance frequency of resonator Ai, f0(i+1) is the resonance frequency of resonator Ai+1, and v is the speed of sound, the spacing P(i) between two consecutive resonators Ai and Ai+1 is within a range of values extending from 50% to 150% of the value of Popt(i).

In a preferred embodiment, the spacing between two resonators varies increasingly or decreasingly along the series of resonators, in the direction going from the inlet to the outlet.

In a preferred embodiment, the spacing between two consecutive resonators Ai and Ai+1 is constant along the series of resonators and corresponds to the mean value of the minimum and maximum values of the optimal spacing Popt(i) over the series of resonators Ai, with i from 1 to N.

In a preferred embodiment, the resonators are all dimensionally different when compared pairwise, so as to ensure an absorption at a different resonance frequency.

In a preferred embodiment, the cavity of each resonator has a substantially tubular shape configured to be open to the channel and has a depth corresponding substantially to a quarter of the wavelength of the acoustic wave of predefined resonance frequency.

In a preferred embodiment, the cross-section of each resonator cavity has curvilinear edges which follow interior and exterior curvatures of the channel.

In a preferred embodiment, the channel is defined radially by outer and inner peripheral walls which are annular around the axis, and transversely by upper and lower walls.

In a preferred embodiment, the upper wall is configured to axially define the depth of the resonance cavities forming the resonators.

Another object of the invention is a centrifugal pump comprising a casing, a shaft extending along a main axis of the pump, an impeller mounted on the shaft, and a motor for rotating the impeller, defining a flow path for a gas stream inside the casing of the pump between an intake port and a discharge port for the gas stream, characterized in that it comprises an acoustic attenuation device according to invention, the acoustic attenuation channel being arranged in a curvilinear configuration around the main axis of the pump inside the casing so that the gas stream circulating in the pump flows through said attenuation channel before it is discharged into the atmosphere through the discharge port of the downstream casing.

In another embodiment, the casing comprises an upstream casing configured to house the impeller and a downstream casing configured to house the motor, the downstream casing comprising a body in the general shape of a cowling defining an outer peripheral wall and an inner peripheral wall extending around a central space for housing the motor, the channel of the attenuation device extending between the two outer and inner walls of the downstream casing.

Lastly, the invention has a pollution-removing device for recovering brake dust particles, in particular those produced by one or more pads of a brake arrangement of a motor vehicle, the device comprising a housing with an inlet port for a flow of dirty air laden with particles and an outlet port for discharging a flow of purified air, and at least one separation member, housed in the housing, through which the flow of air circulates between the inlet and outlet ports in order to separate particles from the flow of dirty air, characterized in that the device comprises a suction member comprising a centrifugal pump according to the invention and in that the intake port is configured to be connected to the outlet port of the housing.

### BRIEF DESCRIPTION OF THE DRAWINGS

Other features and advantages of the invention will become apparent in light of the following description, made with reference to the appended drawings in which:

FIG. 1 illustrates a schematic view of a motor vehicle incorporating a braking particle pollution-removing system;

FIG. 2 illustrates a schematic view of the environment of a wheel of the motor vehicle of FIG. 1, comprising the pollution-removing system of FIG. 1;

FIG. 3 illustrates a schematic view of the pollution-removing system comprising a pollution-removing device according to the invention;

FIG. 4 shows a perspective view of a pollution-removing device corresponding to the pollution-removing device schematically represented in FIG. 3;

FIG. 5 shows an exploded perspective view, from a first angle of view, of a centrifugal pump according to the invention that can be mounted on the pollution-removing device of FIG. 4;

FIG. 6 shows an exploded perspective view, from a second angle of view, of the pump of FIG. 5;

FIG. 7 is a longitudinal section view of the pump of FIGS. 5 and 6;

FIG. 8 is a bottom view of an attenuation device according to the invention, intended to be mounted in the suction member of FIGS. 5 and 6.

FIG. 9 is a top view of the attenuation device of FIG. 8;

FIG. 10 is a schematic view of an acoustic attenuation channel of the acoustic attenuation device of FIGS. 8 and 9;

FIG. 11 is a graph of the evolution in the damping (in decibels) as a function of the frequency (in Hertz) of a quarter-wave resonator of the acoustic attenuation device of the invention;

FIG. 12 is a graph of the evolution in the damping in decibels as a function of the frequency in Hertz of two quarter-wave resonators of the acoustic attenuation device which are spaced apart by a first distance (dotted curve) and a second distance (solid curve);

FIG. 13 illustrates a first graph of the evolution in the damping in decibels as a function of the frequency in Hertz of a centrifugal pump according to the invention comprising the acoustic attenuation device according to the invention comprising a plurality of resonators spaced apart by a single fixed spacing;

FIG. 14 illustrates a second graph of the evolution in the damping in decibels as a function of the frequency in Hertz of a centrifugal pump according to the invention, in which the resonators are spaced apart from each other by an optimal spacing which varies along the resonators.

### DETAILED DESCRIPTION

In the following description, the terms upstream and downstream will be used in relation to the direction of flow of the fluid. Thus, when the description specifies that a first element is upstream of a second element in a system, device, or member, it should be understood that the current of fluid circulating in said system, device, or member passes through the first element before the second element.

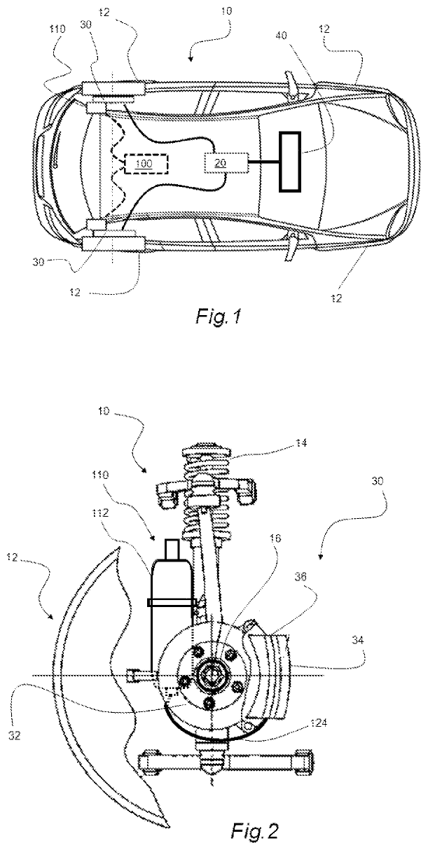

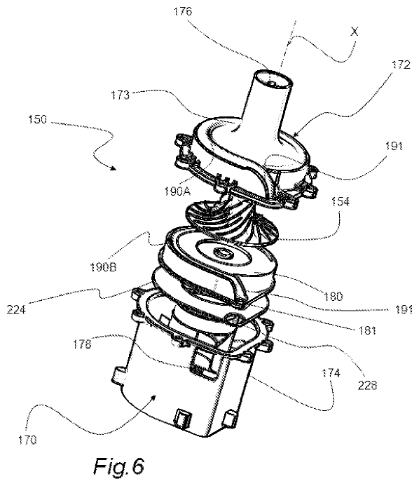

In addition, in the following description, the terms “upper”, “lower”, “above”, “below”, “vertical”, and “horizontal” refer to elements in the position where they are located as represented in FIGS. 1 to 14. Furthermore, in the description, circumferential direction is understood to mean a direction tangential to a near-circular path centered on the main axis X.

Shown in FIG. 1 is a motor vehicle comprising a pollution-removing system based on suction and collection of brake dust particles. This system is designated by the general reference 100, and the motor vehicle is designated by the general reference 10. In the preferred embodiment of the invention, vehicle 10 is a motor vehicle, in the current case a small car. Of course, the invention can be applied to other vehicles, such as heavy trucks, or railway or other vehicles.

In general, but in a non-limiting manner, vehicle 10 comprises four wheels 12 and a braking system 20 whose function is to slow down the vehicle and keep it stationary, in particular for relatively short periods. Braking system 20 is configured to apply braking torque to at least two of wheels 12 of vehicle 10 and preferably to the four wheels 12 of the vehicle. Conventionally, wheels 12 are able to be rotated by a powertrain, for example a combustion engine or an electric motor (not shown) or any other type of propulsion.

For this purpose, braking system 20 preferably comprises four brake arrangements 30 each associated with one of wheels 12, and a management unit for these brake arrangements (only two brake arrangements 30 are shown in FIG. 1). Thus, a user of vehicle 10 can control braking system 20 via a control unit 40 of vehicle 10 which controls brake arrangements 30 of braking system 20.

Such a brake arrangement 30 is illustrated by way of example in FIG. 2. Preferably, arrangement 30 is of the disc brake type. FIG. 2 illustrates brake arrangement 30 mounted on one of wheels 12 of vehicle 10, this wheel 12 being partially represented with its suspension means 14.

Each brake arrangement 30 comprises, in a non-limiting manner, a rotor disc 32 rotating around an axis and integral in rotation with wheel 12 with which it is associated. This axis is generally intended to be fixed to a hub 16 of wheel 12 of vehicle 10.

In addition, brake arrangement 30 comprises a caliper support 34 arranged astride an outer edge of disc 32 and integral in rotation with a fixed part of a frame (not shown) of vehicle 10. Brake arrangement 30 further comprises two brake pads 36 provided with linings made of friction material (not directly visible in the figures) and mounted one on either side of disc 32 by means of caliper support 34.

Brake pads 36 are mounted to be movable, for example under the effect of a hydraulic cylinder (not shown), and are intended to clamp rotor disc 32 in order to brake it until the it stops, converting kinetic energy into thermal energy. The pad linings are generally made of friction material and release particles resulting from the frictional abrasion against disc 32. During braking, the friction between the brake lining and disc 32 generates dust which possibly contains fine particles that are hazardous to health.

In order to recover the braking dust particles, recovery and collection system 100 is intended to suction in and collect dust particles produced during a braking action of motor vehicle 10, from the friction braking of brake arrangements 30 of vehicle 10 as described above.

System 100 comprises at least one pollution-removing device 110 according to the invention, and preferably comprises as many pollution-removing devices 110 as there are brake arrangements 30. For example, system 100 comprises at least two pollution-removing devices 110 to equip the four brake arrangements 30 of vehicle 10. In the following description, only one pollution-removing device 110 will be described in detail, which will usually be designated by the general reference 110.

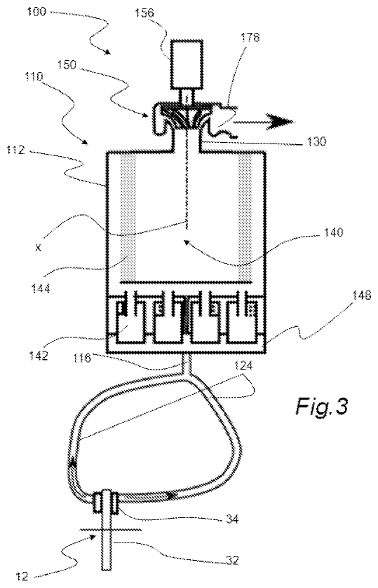

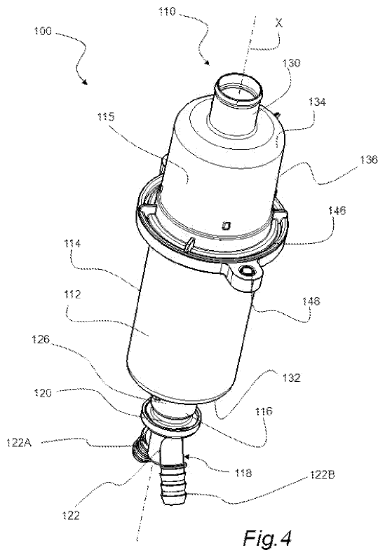

Device 110 has the function of recovering and collecting braking particles and dust, for example coming from one of braking arrangements 30 of the motor vehicle, and is illustrated schematically and functionally in FIGS. 3 and 4.

As illustrated in detail in these figures, device 110 comprises a housing body 112. Housing 112 has a generally tubular shape, for example cylindrical around a main axis X. Housing 112 is for example in two parts 114 and 115 assembled together by various releasable or non-releasable assembly methods which will not be further detailed.

In addition, housing body 112 comprises an inlet port 116 for a flow of dirty air loaded with particles collected from the immediate environment of brake pads 30.

For this purpose, device 110 also comprises a connector end piece 118 intended to be connected to inlet port 116 and to be connected to two flexible hoses 124 having their mouths near brake pads 30 and schematically represented in FIG. 2. End piece 118 is divided along its main axis into a first part 120 intended to be connected to inlet port 116 and a second part 122 separated into two branches 122A and 122B. In the example illustrated, each of branches 122A and 122B of connector end piece 122 has one end for connection to a flexible hose 124, preferably by force-fitting, which is provided for example with a jagged external relief resembling a fir tree. For example, inlet port 116 is in the form of a nozzle 126 and connector end piece 122 is preferably connected by screwing onto connecting nozzle 126 of port 116.

In addition, housing body 112 further comprises an outlet 130 for expelling a flow of purified air. Preferably and in the illustrated example, inlet port 116 and outlet port 130 are respectively formed on end walls 132 and 134 of tubular housing body 112, housing body 112 having for example a substantially cylindrical peripheral wall 136 and end walls 132 and 134 for example having a generally circular shape.

Furthermore, device 110 comprises at least one separation member 140, housed in housing 112, for separating particles from the flow of dirty air, through which the air flow circulates between inlet 116 and outlet 130.

Such a separation member 140 may comprise a filter cartridge 144 or a cyclonic or multi-cyclonic chamber 142, or a combination of the two, as is highly schematically represented in FIG. 3. Such separation members 140 are well known in the prior art and are described in detail for example in patent application CN1864619A with their associated operations and will not be further detailed below.

Furthermore, preferably, housing 112 is sized to be housed within a space surrounding a wheel 12 of a motor vehicle 10, for example around an arm of a suspension shock absorber 14 as shown in FIG. 2. To this end, in the example illustrated, device 110 further comprises a circumferential flange 146 provided with two diametrically opposed radial extension lugs 148, each of the lugs for example being pierced in order to retain a fastening ring (not represented).

In addition, housing 112 is connected, via suction hose 124, to one of disc brake arrangements 30. Preferably, suction hose 124 comprises one end located in the immediate vicinity of the area where brake dust is likely to be generated. The other of its ends preferably leads into the collection body of device 110 via inlet port 116 of housing 112 and the connector end piece 118.

Collection device 110 further comprises, for example, a collection tank 148 housed inside the housing 112 schematically illustrated in FIG. 3. For example, tank 148 is associated with first separation member 142 so as to form a chamber of cyclone separator 142. The purpose of cyclone separator 142 is to capture particles having a diameter for example greater than 10 microns. In the example illustrated, device 110 further comprises a second separation member 144, formed by filter cartridge 144, responsible for handling particles having a diameter of less than 10 microns.

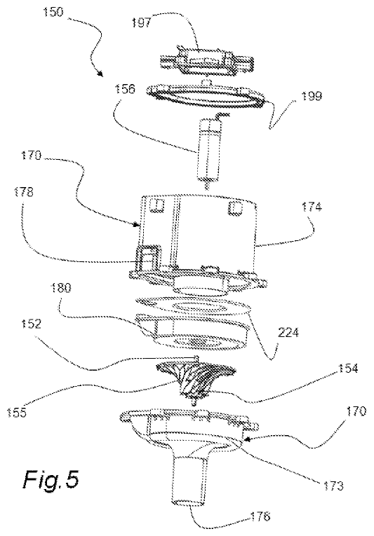

In accordance with the invention, in order to produce effective air circulation inside recovery housing 112 between inlet 116 and outlet 130 of housing 112, device 110 further comprises a suction member 150 which suctions the purified air flow, schematically represented in FIG. 3 and in detail in FIGS. 5 to 7.

In accordance with the invention, air flow suction member 150 comprises a centrifugal suction pump for suctioning the flow of purified air, schematically represented in FIGS. 5 to 7. Pump 150 is mounted at the outlet of housing 112, for example in a sealed fluid connection, directly on outlet port 130 of collection device 110.

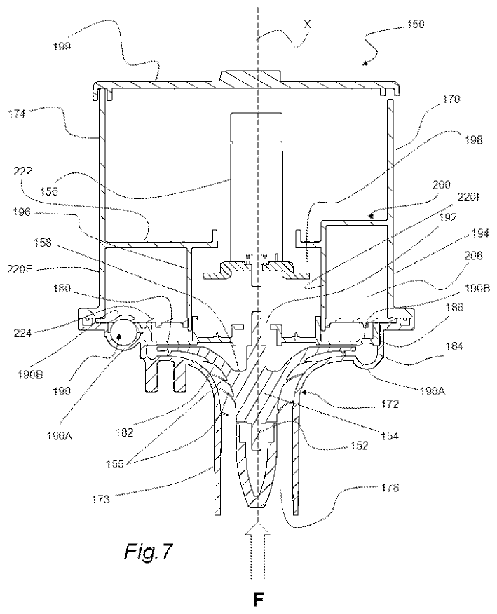

In FIG. 7, arrow F indicates the normal direction of circulation of a fluid in centrifugal pump 150. Below, the terms “upstream” and “downstream” are defined in relation to the normal direction of circulation of fluid in centrifugal pump 150.

In the embodiment of the invention, centrifugal pump 150 comprises a shaft 152, defining a main axis X of pump 150, an impeller 154 mounted on shaft 152, and a motor 156, preferably electric, for rotating impeller 154. Centrifugal pump 150 further comprises a casing 170 to house the aforementioned elements. In this example, casing 170 mainly comprises an upstream casing 172 to house impeller 154 and shaft 152, and a downstream casing 174 to house motor 156.

For example, impeller 154 also comprises a central hub 158 on which shaft 152 is mounted. In the example described, impeller 154 is formed as one piece with shaft 152.

Furthermore, preferably, impeller 154 has a profile adapted to the centrifugal flow of a gas stream inside pump chamber 182. In this example, impeller 154 has the general shape of a truncated cone in which the opening angle at the vertex gradually narrows, for example in a hyperboloid profile. Impeller 154 preferably carries on its outer surface a plurality of guide vanes 155, each extending substantially transversely inside upstream casing 172, as can be seen in FIG. 7.

Furthermore, shaft 152 which extends along the main axis of pump 150 is axially retained by two guide bearings (not shown) positioned substantially at its ends.

Furthermore, casing 170 of centrifugal pump 150 comprises an intake port 176 to admit an incoming air flow and a discharge port 178 to discharge this air flow after circulation inside casing 170.

As illustrated in FIGS. 5 to 7, upstream casing 172 comprises, in the preferred embodiment of the invention, a lower body 173 and an upper body 180 which are assembled together to define a volume within which are shaft 152 and impeller 154.

In the example illustrated in FIGS. 5 to 7, lower body 173 of upstream casing 172 has a generally hollow shape. Lower body 173 is preferably shaped to substantially surround impeller 154. For this purpose, lower body 173 has a narrow upstream annular portion defining intake port 176 at its free upstream end and connected at its other downstream end to a tapered cylindrical downstream portion which gradually widens in the upstream direction.

In the preferred embodiment of the invention, lower body 173 also has a peripheral rim 184 defining an interior space for receiving upper body 180.

Preferably, upper body 180 has the general shape of a bowl having, for example, a substantially flat central bottom connected to an annular peripheral wall forming an annular peripheral rim 186. Preferably, in the substantially flat bottom of upper body 180, a central housing space 192 is provided for the end of shaft 152, ensuring that it is retained along main axis X.

Thus, in this embodiment, the assembly of lower body 173 and upper body 180 is done in a sealed manner, upper body 180 engaging with the lower body to fit therein, for example by the complementary shape of peripheral rim 186 of upper body 180 and peripheral rim 184 of lower body 173.

Furthermore, in this example and in a manner that is known per se, lower body 173 and upper body 180 are configured to form, once assembled, a characteristic internal volume of a centrifugal pump 150, as will be detailed below.

In this example, lower 173 and upper 180 bodies in the assembled state together delimit a toroidal compression chamber 190 for the flow of the gas stream, of substantially circular shape around main axis X of pump 150. Lower 173 and upper 180 bodies each respectively have, for example, on the periphery, a curved relief 190A and 190B of substantially semi-cylindrical shape in a circumferential direction which, by assembly, defines toroidal compression chamber 190 (FIG. 7). Toroidal compression chamber 190 is shaped to allow centrifugal circulation of the gas stream.

In this preferred embodiment, upper body 180 comprises an outlet port 181 for the gas stream of downstream casing 172, after circulation in toroidal compression chamber 190, leading axially to the inside of upstream casing 172.

For this purpose, in this example, compression chamber 190 ends at its downstream end in a duct 191 for discharging the gas stream, connected upstream to outlet port 181 and configured to deviate the direction of flow of the gas stream from its mainly tangential flow direction as it exits toroidal compression chamber 190, to its axial flow direction in outlet port 181 of upstream casing 172.

Preferably, duct 191 has a curvilinear profile and the curve is regular in order to reduce any resistance to the flow of the gas stream so that it reaches outlet port 181.

As illustrated in these figures, downstream casing 174 comprises a cowling of a general almost cylindrical shape defining an outer peripheral wall 194 and an inner peripheral wall 196 extending around a central space 198 for housing motor 156. In addition, in this example, downstream casing 174 comprises a covering wall 199, for example attached by clipping onto outer peripheral wall 194.

It will be noted that, in the illustrated example, the outer peripheral wall of downstream casing 174 does not have a perfectly circular cross-section but is slightly elongated and in the form of a “teardrop”, i.e. having a rounded side and, on the opposite side, tapering to a point. In the illustrated example, the same applies to the geometry of upper body 180 and lower body 173. In this example, this tapered geometry makes it possible to adapt to the geometry of duct 191 which redirects the gas stream exiting toroidal compression chamber 190.

In addition, one will note that casing 170 has securing means for various functions which will not be detailed below. Furthermore, in this example, the figures show a circuit board 197 which may or may not be embedded and which comprises electronic control means for motor 156.

In operation, centrifugal pump 150 is configured to draw air axially through intake port 176, to accelerate it radially inside compression chamber 190, and to discharge the air through intermediate port 181 of compression chamber 190. One will note that discharging the gas stream out of compression chamber 190 occurs axially through intermediate port 181, towards and into downstream casing 174 as will be explained in detail below.

Centrifugal pump 150 further comprises an acoustic attenuation device according to the invention, designated by the general reference 200. Attenuation device 200 is configured to be mounted on the flow path of the fluid inside casing 170 of pump 150, upstream of discharge port 178 of centrifugal pump 150 for release into the atmosphere.

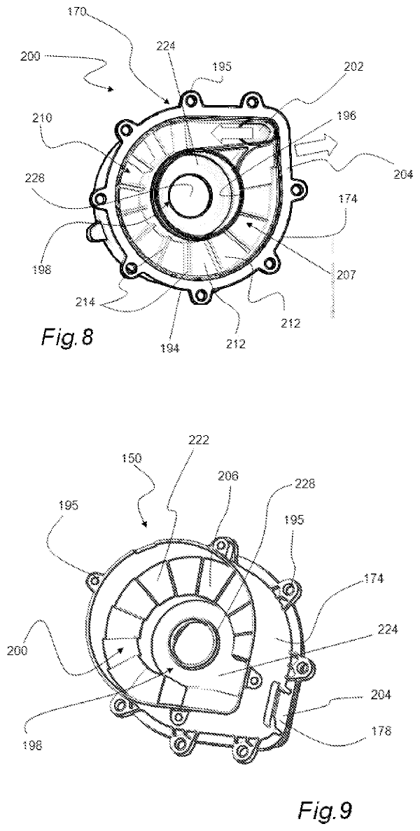

In accordance with the invention, acoustic attenuation device 200, hereinafter referred to as attenuation device 200, is generally intended to be mounted on an electromechanical device through which passes a gas stream capable of propagating acoustic waves, and in the present case, in centrifugal pump 150. With reference to FIGS. 8 and 9, attenuator 200 comprises an inlet port 202 for the gas stream after circulation inside casing 170 of centrifugal pump 150, and in this example after circulation inside compression chamber 190, and an outlet port 204 for the gas stream, in particular for the purpose of discharging it into the atmosphere.

In the preferred embodiment of the invention, gas stream outlet port 204 corresponds to discharge port 178 of centrifugal pump 150, as will be described in more detail below. In this example, inlet port 202 is in fluid communication with outlet port 181 of compression chamber 190.

As is illustrated in FIG. 8, attenuator device 200 is in the form of a channel 206 of generally curvilinear shape defining a substantially curvilinear gas stream path around a main axis between the inlet 202 and outlet 204 ports. In the example described, the main axis of channel 206 is coincident with main axis X of pump 150.

In the example illustrated in the figures, channel 206 has a generally annular shape around main axis X. For example, inlet port 202 and port 204 are arranged adjacent to each other. For example, channel 206 closes onto itself to form a ring by bringing inlet 202 and outlet 204 close to each other. In this case, the flow path follows a near-circular path between inlet port 202 and outlet port 204.

However, in a variant not shown, channel 206 may wind at least partially around the X axis in a spiral configuration, preferably expanding outward between inlet port 202 and outlet port 204.

In particular, device 200 comprises a plurality of acoustic attenuator elements 210 tuned to an attenuation resonance frequency f0 with an associated attenuation frequency band. Resonators 210 are distributed circularly in series along said channel 206 so as to interact with the gas stream flowing in channel 206. According to the invention, acoustic attenuator elements 210 are formed by cavities 212 of quarter-wave resonators.

Recall that the frequency of action f of a quarter-wave resonator is defined, in a first approximation, by the following formula:

$$f = \frac{( 2 n + 1 )}{4} \frac{v}{L}$$

with v designating the speed of sound, n designating an integer (n=0, 1, 2 . . . ) corresponding to a resonant mode, and L designating the effective length of the quarter wave, i.e. the sum of the geometric length of a tube forming the quarter-wave resonator and a fraction of the air volume of the main path for fluid flow that is in communication therewith. To simplify the calculations in the remainder of this description, the fraction of the air volume of the main path will be ignored and the length L of the resonator will be defined as being equal to the depth of the resonant tube.

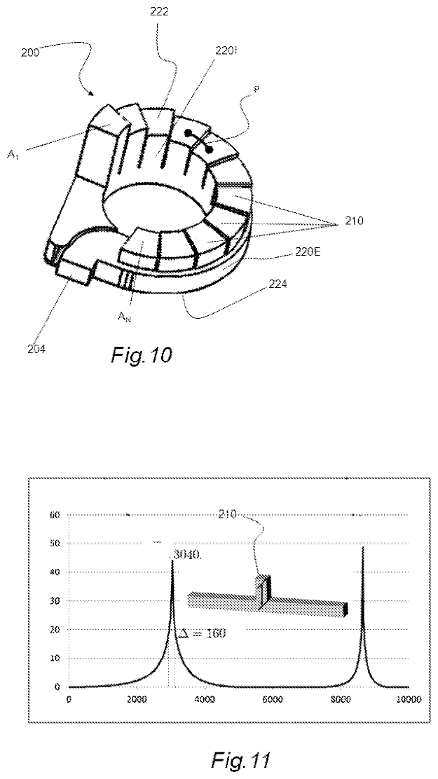

Shown in FIGS. 8 to 10 are a plurality of resonators 210 arranged in series. One will note that in the following description, the resonators in a series Ai with i ranging from 1 to N, A1 being the first resonator 210 of the series, located after inlet 202, and AN being the last resonator 210, located after outlet 204. In FIGS. 8 and 10, the value of N is eleven because there are eleven resonators 210 arranged in series.

In the preferred embodiment of the invention, attenuator device 200 comprises a body 220 provided with annular outer 220E and inner 220I peripheral walls so as to radially define channel 206 around axis X. The body of channel 206 also comprises an upper transverse wall 222 and a lower transverse wall 224 axially defining channel 206. Channel 206 is thus illustrated highly schematically in FIG. 10.

In the preferred embodiment of the invention, channel 206 of attenuation device 200 extends within an annular space defined between the two peripheral outer 194 and inner 196 walls of cowling 174 of pump 150, these two peripheral walls 194 and 196 forming the radially delimiting walls 220E and 220I of channel 206.

Furthermore, one will note that in this preferred embodiment, lower wall 224 is formed by an annular wall (FIG. 8) extending around a central hole 228 which houses motor 156, and closing off channel 206 transversely (as seen in FIG. 7). Furthermore, lower wall 224 comprises a port defining inlet 202 of channel 206, configured to be positioned above outlet port 181 of downstream housing 172.

We will now describe acoustic attenuation channel 206 in more detail. In the embodiment of the invention, channel 206 comprises an internal geometric structure 207, visible for example in FIG. 8, extending along a wall of channel 206, configured to define an internal main flow passage enabling the gas stream to flow freely (generally devoid of any obstacle to the flow of the gas stream) and a plurality of cavities 212 opening into the passage.

Channel 206 is modeled geometrically and highly schematically in FIG. 10. In this FIG. 10, channel 206 comprises a general annular shape in the form of a stepped crown, a first level corresponding to the main flow passage and a second level being compartmentalized or segmented to form the plurality of cavities 212 of resonators 210.

For example, internal geometric structure 207 comprises a plurality of radial separation partitions 214 defining, together with outer 220E and inner 220I walls, compartments forming resonance cavities 212, the partitions 214 being sized to leave an unobstructed main flow passage for the gas stream inside channel 206.

Preferably, one wall of channel 206 has, in a circumferential direction, a stepped profile configured to define cavities 212 with a variable incremental height from one cavity 212 to another. In the preferred embodiment of the invention, the wall of channel 206 having this incrementally stepped profile is formed by upper wall 222 of channel 206 and extends transversely, for example into the interior of downstream casing 174.

Thus, in this embodiment, upper wall 222 is configured to axially define the depth of resonance cavities 212 forming resonators 210. Of course, in a variant not shown, a wall of channel 206 other than upper wall 222 can fulfill this function of defining the depth of cavities 212 of resonators 210, for example outer peripheral wall 220E.

Preferably, the height of one cavity 210 adjacent to another varies increasingly or decreasingly in the direction from inlet 202 to outlet 204, and preferably incrementally.

In FIG. 10, the plurality of resonators 210 is delimited in the axial direction by steps of regularly decreasing height, formed above the unobstructed main flow passage, from inlet 202 to outlet 204. Thus, preferably, as is clearly apparent in FIG. 10, channel 206 has a staircase structure winding around a central cage formed in this example by space 198 for housing motor 156.

For example, as channel 206 has a general shape that is substantially annular, resonators 210 are circumferentially separated by partitions 214 positioned radially along the flow path of the gas stream in channel 206 while leaving a main flow passage, for the gas stream inside channel 206, which is unobstructed (i.e. preferably not partitioned or generally devoid of any obstacle to the flow of the gas stream).

Preferably, cavity 212 of each resonator 210 has a substantially tubular shape configured to have a mouth into channel 206, and in this example into the unobstructed flow passage, and has a depth corresponding to a predefined resonance frequency.

As illustrated in FIG. 8, the cross-section of each cavity 212 of resonator 210 has curvilinear edges in the shape of an arc of a circle, following the interior and exterior outline of channel 206 which is generally annular in shape. Indeed, in the preferred embodiment of the invention, the general shape of cavities 212 is defined internally and externally by the respective internal and external curvatures of channel 206. Of course, the general shape of cavities 212 is not limited to the shape described above.

Preferably, resonators 210 when compared pairwise are all dimensionally different so as to ensure an absorption of each resonator 210 at a different attenuation resonance frequency f0. The integration of a plurality of resonators A1 to AN, all different in their dimensional parameters when compared pairwise, makes it possible to ensure an absorption of each resonator Ai at a different resonance frequency.

It is desirable for these different resonance frequencies f0 to be sufficiently close to each other to obtain a sufficiently large partial overlap of frequency bands, each associated with a resonance frequency of a resonator Ai. This makes it possible to obtain an expanded and continuous band of attenuation frequencies. This is achieved by choosing appropriate dimensions for resonators 210 and appropriate spacings between them, as will be explained below.

In this specific application of noise pollution related to the operation of the centrifugal pump, the frequency band to be processed is between 2000 Hz and 8000 Hz and the requirement is to obtain an attenuation (“Transmission Loss”) having a minimum value of 20 dB on this frequency band.

Shown in FIG. 11 is a graph comprising a curve of the damping (in decibels) along the y axis as a function of the frequency (in Hertz) along the x axis, of a resonator 210 having a resonance frequency f0 located around 3000 Hertz.

In the graph, one will observe two frequency peaks of about 3000 Hertz, corresponding to the main resonant mode (n=0), and 8500 Hertz (n=1), corresponding to a harmonic mode, each associated with an attenuation bandwidth at twenty decibels of approximately 160 Hertz and 80 Hertz respectively. Consequently, one will note that with a single resonator 210, the attenuation takes place discretely and not over a continuous range of frequencies. In the following, “associated frequency band” will designate the frequency band associated with a resonance frequency of a resonator within which the attenuation is greater than twenty decibels,

Thus, preferably, in the preferred embodiment of the invention, at least two resonators 210 have resonance frequencies f0 that are sufficiently close for their associated frequency bands to partially overlap. The circumferential distance separating at least two resonators 210 of the series will be chosen so that a coupling phenomenon occurs between the two resonators 210 by continuous spectral overlap of their frequency bands of attenuation greater than twenty decibels. This makes it possible to produce an expanded continuous frequency band of attenuation greater than twenty decibels.

Within the meaning of the invention, the circumferential distance is defined from center to center for each resonator 210 along a circular guiding centerline of channel 206, as schematically illustrated in FIG. 10. The spacing P is defined as the circumferential distance separating two consecutive resonators of the series.

It has thus been noticed that, for certain values of spacing P, the portion of channel 206 extending between two adjacent resonators 210 behaves like an “open-open” resonant tube which can be the source of a phenomenon known as “antiresonance”. The portion of channel 206 separating the two resonators 210 behaves like an open-open resonant tube which will amplify the acoustic waves close to the resonance frequency of the two adjacent resonators 210 by constructive interference of the acoustic waves. These constructive interferences will be reflected on the spectral curve by a phenomenon of antiresonance of the attenuation in decibels, forming an inverted peak.

In order to avoid the antiresonance phenomenon between the two adjacent resonators 210, which could reduce the overall effectiveness of the acoustic attenuation device, it is desirable to select the circumferential distance P in a predefined manner.

Indeed, surprisingly it has been observed that in order to produce this coupling phenomenon without antiresonance between two adjacent resonators Ai and Ai+1 in the series, the optimal circumferential distance, designated by Popt(i), between two adjacent resonators Ai and Ai+1 must satisfy the following formula for determining the optimal spacing:

$$Popt ( i ) = \frac{{L}_{( i )} + {L}_{( i + 1 )}}{2} \\ L ( i ) = \frac{{λ}_{( i )}}{4} = \frac{v}{4 f {0}_{( i )}}$$

otherwise expressed as:

$$Popt ( i ) = \frac{v}{8} \times ( \frac{1}{f {0}_{( i )}} + \frac{1}{f {0}_{( i + 1 )}} )$$

with v: speed of sound in air (which is approximately 344 meters per second at 20° C. and at sea level).
L(i): depth of resonance cavity Ai
f0(i): resonance frequency of resonator Ai
f0(i+1): resonance frequency of resonator Ai+1.

Note that although an optimal coupling phenomenon is observed for a spacing value substantially equal to Popt(i), a sufficient result is obtained within a range of spacing values P(i) defined as follows, with a tolerance of up to 50% for the optimum spacing value Popt(i) for a resonator Ai:

P(i)∈[0.5×Popt(i); 1.5×Popt(i)]

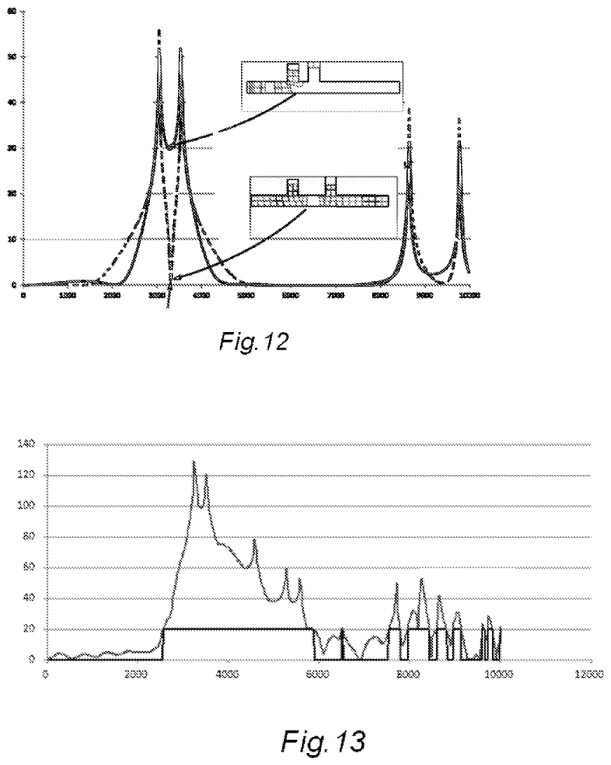

The attenuation curves are represented in FIG. 12, expressed in decibels along the y axis, as a function of the frequency (expressed in Hertz) along the x axis, for two consecutive resonators 210 of resonance frequencies equal to 3000 Hertz and 3500 Hertz, separated by a circumferential distance of 56 millimeters (dotted lines) and separated by a circumferential distance of 27 millimeters (solid line).

According to the above formula, spacing P between these two resonators 210 must be within the range of values in millimeters of [13.3; 39.9], with optimal coupling around a Popt value of 27 millimeters.

The first curve is represented as a dotted line and illustrates the attenuation obtained with two resonators 210 separated by a circumferential distance equal to 56 millimeters, therefore located outside the recommended range as defined and obtained above. An antiresonance peak is observed around the frequency of 3320 Hz.

The second curve, represented as a solid line, illustrates the attenuation in decibels obtained by the two consecutive resonators, this time separated by a circumferential distance equal to 27 millimeters. In the portion of channel 206 separating the two resonators 210, a phenomenon of destructive interference by the acoustic waves having frequencies close to the resonance frequency will occur. These destructive interferences will be reflected in the spectral curve by a coupling phenomenon between the attenuation resonance frequencies of the two adjacent resonators, as is clearly shown in the curve having a solid line.

As is clear from this second curve, the coupling phenomenon between the two consecutive resonators 210 has the effect of producing a continuous band of attenuation of frequencies above twenty decibels between the two resonance frequencies associated with the two resonators 210.

In the preferred embodiment of the invention, the spacing between two adjacent resonators 210 varies increasingly or decreasingly along the series of resonators Ai, and the spacing P(i) defined between resonator Ai and resonator Ai+1 is comprised between the spacing P(i−1) defined between resonator Ai−1 and resonator Ai and the spacing P(i+1) of resonator Ai+1 and resonator Ai+2.

For example, by seeking an attenuation of at least twenty decibels in the frequency range 2000 Hertz to 5500 Hertz, with resonance frequencies every 500 Hertz, the optimal spacing Popt(i) between resonator Ai and resonator Ai+1 varies within the frequency range of 16 millimeters to 39 millimeters.

In the illustrated embodiment of the invention, spacing P can be chosen to be constant between two resonators 210 in the series of resonators 210, for example taking as the spacing value the mean of the minimum optimal spacing Poptmin and the optimal spacing Poptmax among all the optimal spacings Popt(i) defined for the series of resonators Ai, otherwise expressed by the formula for determining the mean spacing Pmean below:

$${P}_{mean} = \frac{{Popt}_{min} + {Popt}_{max}}{2}$$

$${Popt}_{min} = Minimum ( Popt ( i ) ) ∀ i and {Popt}_{max} = Maximum ( Popt ( i ) ) ∀ i$$

Shown in FIG. 13 is a first graph illustrating the curve representing the attenuation in decibels as a function of the frequency in Hertz for the attenuation device of the invention, in which the spacing corresponds to a constant spacing over the series of resonators 210 and chosen in accordance with the formula described above for defining a mean spacing Pmean.

The resonance frequencies f0 of resonators A1 to AN are chosen to be between 2500 Hertz and 6000 Hertz, in increments of 500 Hertz.

Note that with this constant spacing, the curve presents a wide range of attenuated frequencies of at least 20 decibels, in particular between 2500 Hertz and 6000 Hertz.

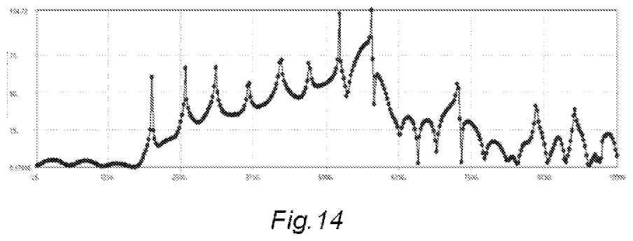

Shown in FIG. 14 is a second graph illustrating the curve representing the attenuation in decibels as a function of the frequency in Hertz for the attenuation device of the invention, in which the spacing between two adjacent resonators Ai and Ai+1 varies over the series of resonators 210 and is chosen in accordance with the optimum spacing formula Popt(i).

An attenuation (“Transmission Loss”) is obtained that has a minimum value of 20 dB on the frequency band between approximately 2000 Hz and 6300 Hz, with a maximum attenuation for the frequencies between 5000 Hz and 6300 Hz.

The main aspects of the operation of the braking particle recovery system according to the invention will now be described.

During a first step, the user of vehicle 10 activates the brake of vehicle 10. During this braking action, brake dust particles related to the abrasion of the brake linings are released. When the brake is actuated, the braking system simultaneously drives the activation of centrifugal pumps 150 associated with each brake arrangement 30.

In suction member 150, the activation of the rotation of impeller 154 will produce a suction effect which will drive the flow of purified air through member 150. Thus, the flow of dirty air is drawn by suction through the hose and enters housing 112. Some of its dust particles are removed via separation member(s) 140 which it passes through during its travel within housing 112 of device 110. The flow of dirty air purified in this manner exits through outlet port 130 of housing 112 and enters member 150.

For this purpose, the gas stream is suctioned into casing 170 of pump 150 via intake port 176. Impeller 154 housed in downstream casing 172 is driven to rotate by motor 156 so as to suction axially, accelerate radially, and tangentially discharge the gas stream which is deflected axially through duct 191 all the way to port 181 at the outlet of compression chamber 190. The gas stream enters channel 206 axially through inlet port 202 then is discharged through the outlet port of channel 206 as well as through discharge port 178 of pump 150. Along acoustic attenuation channel 206, sound waves are attenuated by at least 20 decibels in the frequency band between 2500 Hertz and 6000 Hertz, by means of the series of resonators 210 arranged along channel 206.

In the example illustrated in the graph of FIG. 13 or FIG. 14, one can see in particular that within a range of chosen frequencies of between 2500 Hertz and 6000 Hertz, acoustic attenuation channel 206 makes it possible to substantially reduce the noises generated by pump 150 within this range.

The invention has the advantage of being compact, allowing for example its integration into the motor shroud of a centrifugal pump while being particularly efficient within the desired frequency range.

The invention is not limited to the embodiments described above. Other embodiments within the reach of those skilled in the art can also be envisaged without departing from the scope of the invention defined by the claims below. Thus, in particular, one would not exceed the scope of the invention by modifying details in the shapes of the pump and channel.

1. Acoustic attenuation device for an electromechanical device through which passes a gas stream capable of propagating acoustic waves, comprising inlet and outlet ports for a gas stream, the device comprising a channel of an overall shape that is generally curvilinear around a main axis of the device, defining a substantially curvilinear flow path for the gas stream between the inlet and outlet ports, and comprises a plurality of acoustic attenuator elements tuned to an attenuation resonance frequency, arranged consecutively in series along said channel so as to interact with the gas stream flowing in the channel, the acoustic attenuator elements being formed by cavities of quarter-wave resonators and being referred to as resonators, a wall of the channel having a stepped profile defining an incremental depth which varies from one cavity to another along a circumferential direction of the channel.

2. The device according to claim 1, wherein the channel has an overall shape that is generally annular around the axis defining a near-circular flow path between the inlet and outlet ports, or the channel at least partially winds in an outwardly expanding spiral configuration between the inlet port and the outlet port.

3. The device according to claim 1, wherein the channel is provided with an internal geometric structure extending inside the channel in a substantially circumferential direction, configured to define the plurality of cavities and to leave free of obstructions to the flow of the gas stream a main passage which the cavities are open to.

4. The device according to claim 3, wherein the internal geometric structure comprises a plurality of radial separation partitions which define, with the walls of the channel a plurality of compartments forming the plurality of cavities.

5. (canceled)

6. The device according to claim 1, wherein the depth from one cavity to another varies increasingly or decreasingly over the series of resonators, in the direction going from the inlet to the outlet.

7. The device according to claim 1, wherein at least first and second resonators having first and second resonance frequencies respectively associated with first and second frequency bands of attenuation greater than twenty decibels, the circumferential distance between the two resonators is determined so as to produce a coupling phenomenon between the two resonators over a continuous frequency band of attenuation greater than twenty decibels.

8. The device according to claim 1, wherein an optimal spacing Popt(i) between two consecutive resonators Ai and Ai+1 being given by the following formula:
$$Popt ( i ) = \frac{v}{8} \times ( \frac{1}{f {0}_{i}} + \frac{1}{f {0}_{i + 1}} )$$
where f0(i) is the resonance frequency of resonator Ai, f0(i+1) is the resonance frequency of resonator Ai+1, and v is the speed of sound, the spacing P(i) between two consecutive resonators Ai and Ai+1 is within a range of values extending from 50% to 150% of the value of Popt(i).

9. The device according to claim 1, wherein the spacing between two resonators varies increasingly or decreasingly along the series of resonators, in the direction going from the inlet to the outlet.

10. The device according to claim 8, wherein the spacing between two consecutive resonators Ai and Ai+1 is constant along the series of a number N of resonators and corresponds to the mean value of the minimum and maximum values of the optimal spacing Popt(i) over the series of resonators Ai, with i from 1 to N.

11. The device according to claim 1, wherein the resonators are all dimensionally different when compared pairwise, so as to ensure an absorption at a different resonance frequency.

12. The device according to claim 1, wherein the cavity of each resonator has a substantially tubular shape configured to be open to the channel and has a depth corresponding substantially to a quarter of the wavelength of the acoustic wave of predefined resonance frequency.

13. The device according to claim 12, wherein the cross-section of each resonator cavity has curvilinear edges which follow interior and exterior curvatures of the channel.

14. The device according to claim 1, wherein the channel is defined radially by outer and inner peripheral walls which are annular around the axis, and transversely by upper and lower walls.

15. The device according to claim 14, wherein the upper wall is configured to axially define the depth of the resonance cavities forming the resonators.

16. Centrifugal pump, comprising a casing, a shaft extending along a main axis of the pump, an impeller mounted on the shaft, a motor for rotating the impeller, defining a flow path for a gas stream inside the casing of the pump between an intake port and a discharge port for the gas stream, the centrifugal pump comprising the acoustic attenuation device according to claim 1, the acoustic attenuation channel being arranged in a curvilinear configuration around the main axis of the pump inside the casing so that the gas stream circulating in the pump flows through said attenuation channel before being discharged into the atmosphere through the discharge port of the downstream casing.

17. The centrifugal pump according to claim 16, wherein the casing comprises an upstream casing configured to house the impeller and a downstream casing configured to house the motor, the downstream casing comprising a body in the general shape of a cowling defining an outer peripheral wall and an inner peripheral wall extending around a central space for housing the motor, the channel of the attenuation device extending between the two outer and inner walls of the downstream casing.

18. Pollution-removing device for recovering brake dust particles, the device comprising a housing with an inlet port for a flow of dirty air laden with particles and an outlet port for the discharging a flow of purified air, and at least one separation member, housed in the housing, through which the air flow circulates between the inlet and outlet ports in order to separate particles from the flow of dirty air, wherein the device comprises a suction member comprising a centrifugal pump according to claim 16 and wherein the intake port of the pump is configured to be connected to the outlet port of the housing.

19. Pollution-removing device for recovering brake dust particles, the device comprising a housing with an inlet port for a flow of dirty air laden with particles and an outlet port for the discharging a flow of purified air, and at least one separation member, housed in the housing, through which the air flow circulates between the inlet and outlet ports in order to separate particles from the flow of dirty air, wherein the device comprises a suction member comprising a centrifugal pump according to claim 17 and wherein the intake port of the pump is configured to be connected to the outlet port of the housing.
